(19) United States
(12) Patent Application Publication
(10) Pub. No.: US 2015/0187390 A1
(43) Pub. Date: Jul. 2, 2015

(54) VIDEO METADATA

(71) Applicant: LYVE MINDS, INC., Cupertino, CA (US)

(72) Inventors: Mihnea Calin Pacurariu, Los Gatos, CA (US); Andreas von Sneidern, San Jose, CA (US); Rainer Brodersen, Cupertino, CA (US)

(73) Assignee: LYVE MINDS, INC., Cupertino, CA (US)

(21) Appl. No.: 14/143,335

(22) Filed: Dec. 30, 2013

(51) Int. Cl. G11B 27/10; H04N 5/91; H04N 5/77

(52) U.S. Cl. CPC G11B 27/10; H04N 5/772; H04N 5/91

(57) ABSTRACT

Systems and methods are disclosed to provide video data structures that include one or more tracks that comprise different types of metadata. The metadata, for example, may include data representing various environmental conditions such as location, positioning, motion, speed, acceleration, etc. The metadata, for example, may also include data representing various video or audio tags such as people tags, audio tags, motion tags, etc. Some or all of the metadata, for example, may be recorded in conjunction with a specific video frame of a video clip. Some or all of the metadata, for example, may be recorded in a continuous fashion and/or may be recorded in conjunction with one or more of a plurality of specific video frames.

### FIELD

This disclosure relates generally to video metadata.

### BACKGROUND

Digital video is becoming as ubiquitous as photographs. The reduction in size and the increase in quality of video sensors have made video cameras more and more accessible for any number of applications. Mobile phones with video cameras are one example of video cameras being more accessible and usable. Small portable video cameras that are often wearable are another example. The advent of YouTube, Instagram, and other social networks has increased users' ability to share video with others.

### SUMMARY

These illustrative embodiments are mentioned not to limit or define the disclosure, but to provide examples to aid understanding thereof. Additional embodiments are discussed in the Detailed Description, and further description is provided there. Advantages offered by one or more of the various embodiments may be further understood by examining this specification or by practicing one or more embodiments presented.

Embodiments of the invention include a camera including an image sensor, a motion sensor, a memory, and a processing unit. The processing unit can be electrically coupled with the image sensor, the microphone, the motion sensor, and the memory. The processing unit may be configured to receive a plurality of video frames from the image sensor, wherein the plurality of video frames comprise a video clip; receive motion data from the motion sensor; and store the motion data in association with the video clip.

In some embodiments, the motion data may be stored in association with each of the plurality of video frames. In some embodiments, the motion data may include first motion data and second motion data and the plurality of video frames may include a first video frame and a second video frame. The first motion data may be stored in association with the first video frame; and the second motion data may be stored in association with the second video frame. In some embodiments, the first motion data and the first video frame may be time stamped with a first time stamp, and the second motion data and the second video frame may be time stamped with a second time stamp.

In some embodiments, the camera may include a GPS sensor. The processing unit may be further configured to receive GPS data from the GPS sensor; and store the motion data and the GPS data in association with the video clip. In some embodiments, the motion sensor may include an accelerometer, a gyroscope, and/or a magnetometer.

Embodiments of the invention include a camera including an image sensor, a GPS sensor, a memory, and a processing unit. The processing unit can be electrically coupled with the image sensor, the microphone, the GPS sensor, and the memory. The processing unit may be configured to receive a plurality of video frames from the image sensor, wherein the plurality of video frames comprise a video clip; receive GPS data from the GPS sensor; and store the GPS data in association with the video clip. In some embodiments, the GPS data may be stored in association with each of the plurality of video frames.

In some embodiments, the GPS data may include first GPS data and first motion data; and the plurality of video frames may include a first video frame and a second video frame. The first GPS data may be stored in association with the first video frame; and the second GPS data may be stored in association with the second video frame. In some embodiments, the first GPS data and the first video frame may be time stamped with a first time stamp, and the second GPS data and the second video frame may be time stamped with a second time stamp.

A method for collecting video data is also provided according to some embodiments described herein. The method may include receiving a plurality of video frames from an image sensor, wherein the plurality of video frames comprise a video clip; receiving GPS data from a GPS sensor; receiving motion data from a motion sensor; and storing the motion data and the GPS data in association with the video clip.

In some embodiments, the motion data may be stored in association with each of the plurality of video frames. In some embodiments, the GPS data may be stored in association with each of the plurality of video frames. In some embodiments, the method may further include receiving audio data from a microphone; and storing the audio data in association with the video clip.

In some embodiments, the motion data may include acceleration data, angular rotation data, direction data, and/or a rotation matrix. In some embodiments, the GPS data may include a latitude, a longitude, an altitude, a time of the fix with the satellites, a number representing the number of satellites used to determine GPS data, a bearing, and/or a speed.

A method for collecting video data is also provided according to some embodiments described herein. The method may include receiving a first video frame from an image sensor; receiving first GPS data from a GPS sensor; receiving first motion data from a motion sensor; storing the first motion data and the first GPS data in association with the first video frame; receiving a second video frame from the image sensor; receiving second GPS data from the GPS sensor; receiving second motion data from the motion sensor; and storing the second motion data and the second GPS data in association with the second video frame. In some embodiments, the first motion data, the first GPS data, and the first video frame are time stamped with a first time stamp, and the second motion data, the second GPS data, and the second video frame are time stamped with a second time stamp.

### BRIEF DESCRIPTION OF THE FIGURES

These and other features, aspects, and advantages of the present disclosure are better understood when the following Detailed Description is read with reference to the accompanying drawings.

FIG. 1 illustrates an example camera system according to some embodiments described herein.

FIG. 2 illustrates an example data structure according to some embodiments described herein.

FIG. 3 illustrates an example data structure according to some embodiments described herein.

FIG. 4 illustrates another example of a packetized video data structure that includes metadata according to some embodiments described herein.

FIG. 5 is an example flowchart of a process for associating motion and/or geolocation data with video frames according to some embodiments described herein.

FIG. 6 is an example flowchart of a process for voice tagging video frames according to some embodiments described herein.

FIG. 7 is an example flowchart of a process for people tagging video frames according to some embodiments described herein.

FIG. 8 is an example flowchart of a process for sampling and combining video and metadata according to some embodiments described herein.

FIG. 9 shows an illustrative computational system for performing functionality to facilitate implementation of embodiments described herein.

### DETAILED DESCRIPTION

More and more video recording devices are equipped with motion and/or location sensing hardware among other sensing hardware. Embodiments of the invention include systems and/or methods for recording or sampling the data from these sensors synchronously with the video stream. Doing so, for example, may infuse a rich environmental awareness into the media stream.

Systems and methods are disclosed to provide video data structures that include one or more tracks that contain different types of metadata. The metadata, for example, may include data representing various environmental conditions such as location, positioning, motion, speed, acceleration, etc. The metadata, for example, may also include data representing various video or audio tags such as people tags, audio tags, motion tags, etc. Some or all of the metadata, for example, may be recorded in conjunction with a specific video frame of a video clip. Some or all of the metadata, for example, may be recorded in a continuous fashion and/or may be recorded in conjunction with one or more of a plurality of specific video frames.

Various embodiments of the invention may include a video data structure that includes metadata that is sampled (e.g. a snapshot in time) at a data rate that is less than or equal to the video track (e.g. 30 Hz or 60 Hz). In some embodiments, the metadata may reside within the same media container as the audio and/or video portion of the file or stream. In some embodiments the data structure may include with a number of different media players and editors. In some embodiments, the metadata may be extractable and/or decodable from the data structure. In some embodiments, the metadata may be extensible for any type of augmentative real time data.

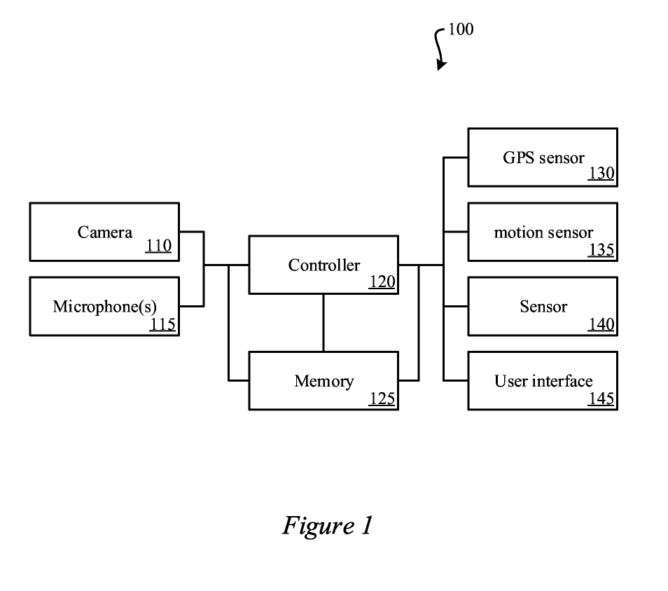

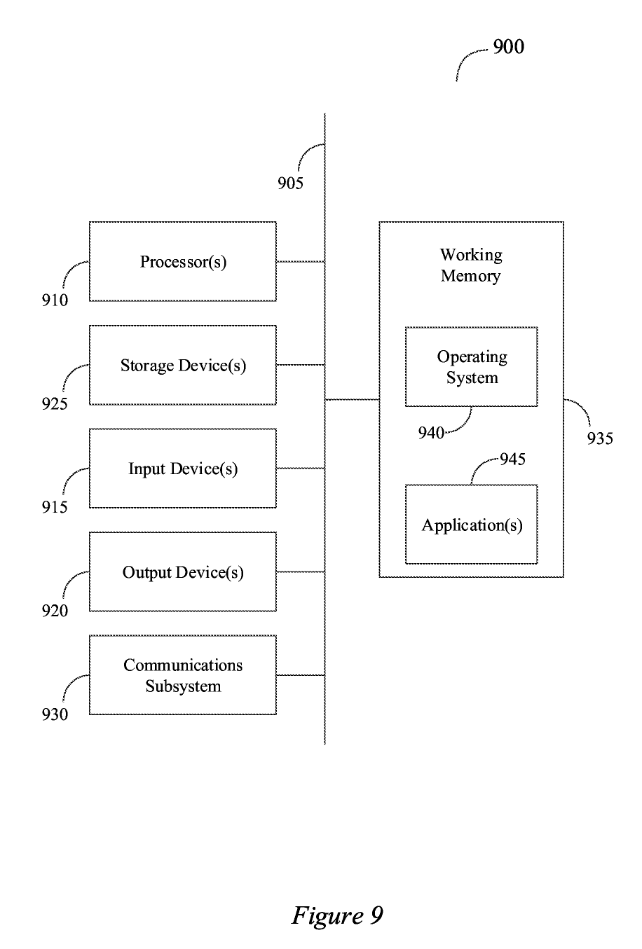

FIG. 1 illustrates an example camera system 100 according to some embodiments described herein. The camera system 100 includes a camera 110, a microphone 115, a controller 120, a memory 125, a GPS sensor 130, a motion sensor 135, sensor(s) 140, and/or a user interface 145. The controller 120 may include any type of controller, processor or logic. For example, the controller 120 may include all or any of the components of computational system 900 shown in FIG. 9.

The camera 110 may include any camera known in the art that records digital video of any aspect ratio, size, and/or frame rate. The camera 110 may include an image sensor that samples and records a field of view. The image sensor, for example, may include a CCD or a CMOS sensor. For example, the aspect ratio of the digital video produced by the camera 110 may be 1:1, 4:3, 5:4, 3:2, 16:9, 10:7, 9:5, 9:4, 17:6, etc., or any other aspect ratio. As another example, the size of the camera's image sensor may be 9 megapixels, 15 megapixels, 20 megapixels, 50 megapixels, 100 megapixels, 200 megapixels, 500 megapixels, 1000 megapixels, etc., or any other size. As another example, the frame rate may be 24 frames per second (fps), 25 fps, 30 fps, 48 fps, 50 fps, 72 fps, 120 fps, 300 fps, etc., or any other frame rate. The frame rate may be an interlaced or progressive format. Moreover, camera 110 may also, for example, record 3-D video. The camera 110 may provide raw or compressed video data. The video data provided by camera 110 may include a series of video frames linked together in time. Video data may be saved directly or indirectly into the memory 125.

The microphone 115 may include one or more microphones for collecting audio. The audio may be recorded as mono, stereo, surround sound (any number of tracks), Dolby, etc., or any other audio format. Moreover, the audio may be compressed, encoded, filtered, compressed, etc. The audio data may be saved directly or indirectly into the memory 125. The audio data may also, for example, include any number of tracks. For example, for stereo audio, two tracks may be used. And, for example, surround sound 5.1 audio may include six tracks.

The controller 120 may be communicatively coupled with the camera 110 and the microphone 115 and/or may control the operation of the camera 110 and the microphone 115. The controller 120 may also be used to synchronize the audio data and the video data. The controller 120 may also perform various types of processing, filtering, compression, etc. of video data and/or audio data prior to storing the video data and/or audio data into the memory 125.

The GPS sensor 130 may be communicatively coupled (either wirelessly or wired) with the controller 120 and/or the memory 125. The GPS sensor 130 may include a sensor that may collect GPS data. In some embodiments, the GPS data may be sampled and saved into the memory 125 at the same rate as the video frames are saved. Any type of the GPS sensor may be used. GPS data may include, for example, the latitude, the longitude, the altitude, a time of the fix with the satellites, a number representing the number of satellites used to determine GPS data, the bearing, and speed. The GPS sensor 130 may record GPS data into the memory 125. For example, the GPS sensor 130 may sample GPS data at the same frame rate as the camera records video frames and the GPS data may be saved into the memory 125 at the same rate. For example, if the video data is recorded at 24 fps, then the GPS sensor 130 may be sampled and stored 24 times a second. Various other sampling times maybe used. Moreover, different sensors may sample and/or store data at different sample rates.

The motion sensor 135 may be communicatively coupled (either wirelessly or wired) with the controller 120 and/or the memory 125. The motion sensor 135 may record motion data into the memory 125. The motion data may be sampled and saved into the memory 125 at the same rate as video frames are saved in the memory 125. For example, if the video data is recorded at 24 fps, then the motion sensor may be sampled and stored in data 24 times a second.

The motion sensor 135 may include, for example, an accelerometer, gyroscope, and/or a magnetometer. The motion sensor 135 may include, for example, a nine-axis sensor that output raw data in three axes for each individual sensor: acceleration, gyroscope, and magnetometer, or it can output a rotation matrix that describes the rotation of the sensor about the three Cartesian axes. Moreover, the motion sensor 135 may also provide acceleration data. The motion sensor 135 may be sampled and the motion data saved into the memory 125.

Alternatively, the motion sensor 135 may include separate sensors such as a separate one-three axis accelerometer, a gyroscope, and/or a magnetometer. The raw or processed data from these sensors may be saved in the memory 125 as motion data.

The sensor(s) 140 may include any number of additional sensors communicatively coupled (either wirelessly or wired) with controller 120 such as, for example, an ambient light sensor, a thermometer, barometric pressure, heart rate, pulse, etc. The sensor(s) 140 may be communicatively coupled with the controller 120 and/or the memory 125. The sensor(s), for example, may be sampled and the data stored in the memory at the same rate as the video frames are saved or lower rates as practical for the selected sensor data stream. For example, if the video data is recorded at 24 fps, then the sensor(s) may be sampled and stored 24 times a second and GPS may be sampled at 1 fps.

The user interface 145 may be communicatively coupled (either wirelessly or wired) and may include any type of input/output device including buttons and/or a touchscreen. The user interface 145 may be communicatively coupled with the controller 120 and/or the memory 125 via wired or wireless interface. The user interface may provide instructions from the user and/or output data to the user. Various user inputs may be saved in the memory 125. For example, the user may input a title, a location name, the names of individuals, etc. of a video being recorded. Data sampled from various other devices or from other inputs may be saved into the memory 125.

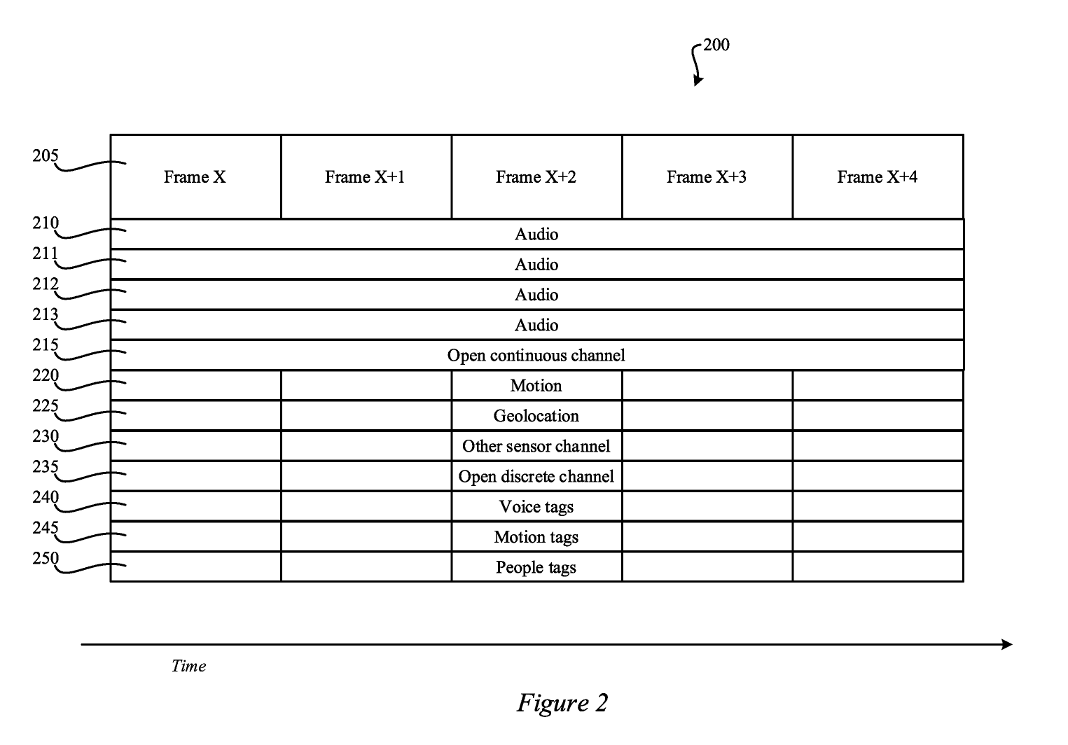

FIG. 2 is an example diagram of a data structure 200 for video data that includes video metadata according to some embodiments described herein. Data structure 200 shows how various components are contained or wrapped within data structure 200. In FIG. 2, time runs along the horizontal axis and video, audio, and metadata extends along the vertical axis. In this example, five video frames 205 are represented as Frame X, Frame X+1, Frame X+2, Frame X+3, and Frame X+4. These video frames 205 may be a small subset of a much longer video clip. Each video frame 205 may be an image that when taken together with the other video frames 205 and played in a sequence comprises a video clip.

Data structure 200 also includes four audio tracks 210, 211, 212, and 213. Audio from the microphone 115 or other source may be saved in the memory 125 as one or more of the audio tracks. While four audio tracks are shown, any number may be used. In some embodiments, each of these audio tracks may comprise a different track for surround sound, for dubbing, etc., or for any other purpose. In some embodiments, an audio track may include audio received from the microphone 115. If more than one the microphone 115 is used, then a track may be used for each microphone. In some embodiments, an audio track may include audio received from a digital audio file either during post processing or during video capture.

The audio tracks 210, 211, 212, and 213 may be continuous data tracks according to some embodiments described herein. For example, video frames 205 are discrete and have fixed positions in time depending on the frame rate of the camera. The audio tracks 210, 211, 212, and 213 may not be discrete and may extend continuously in time as shown. Some audio tracks may have start and stop periods that are not aligned with the frames 205 but are continuous between these start and stop times.

Open track 215 is an open track that may be reserved for specific user applications according to some embodiments described herein. Open track 215 in particular may be a continuous track. Any number of open tracks may be included within data structure 200.

The motion track 220 may include motion data sampled from the motion sensor 135 according to some embodiments described herein. The motion track 220 may be a discrete track that includes discrete data values corresponding with each video frame 205. For instance, the motion data may be sampled by the motion sensor 135 at the same rate as the frame rate of the camera and stored in conjunction with the video frames 205 captured while the motion data is being sampled. The motion data, for example, may be processed prior to being saved in the motion track 220. For example, raw acceleration data may be filtered and or converted to other data formats.

The motion track 220, for example, may include nine sub-tracks where each sub-track includes data from a nine-axis accelerometer-gyroscope sensor according to some embodiments described herein. As another example, the motion track 220 may include a single track that includes a rotational matrix. Various other data formats may be used.

The geolocation track 225 may include location, speed, and/or GPS data sampled from the GPS sensor 130 according to some embodiments described herein. The geolocation track 225 may be a discrete track that includes discrete data values corresponding with each video frame 205. For instance, the motion data may be sampled by the GPS sensor 130 at the same rate as the frame rate of the camera and stored in conjunction with the video frames 205 captured while the motion data is being sampled.

The geolocation track 225, for example, may include three sub-tracks where each sub-track represents the latitude, longitude, and altitude data received from the GPS sensor 130. As another example, the geolocation track 225 may include six sub-tracks where each sub-track includes three-dimensional data for velocity and position. As another example, the geolocation track 225 may include a single track that includes a matrix representing velocity and location. Another sub-track may represent the time of the fix with the satellites and/or a number representing the number of satellites used to determine GPS data. Various other data formats may be used.

The other sensor track 230 may include data sampled from sensor 140 according to some embodiments described herein. Any number of additional sensor tracks may be used. The other sensor track 230 may be a discrete track that includes discrete data values corresponding with each video frame 205. The other sensor track may include any number of sub-tracks.

Open discrete track 235 is an open track that may be reserved for specific user or third-party applications according to some embodiments described herein. Open discrete track 235 in particular may be a discrete track. Any number of open discrete tracks may be included within data structure 200.

Voice tagging track 240 may include voice initiated tags according to some embodiments described herein. Voice tagging track 240 may include any number of sub-tracks; for example, sub-track may include voice tags from different individuals and/or for overlapping voice tags. Voice tagging may occur in real time or during post processing. In some embodiments, voice tagging may identify selected words spoken and recorded through the microphone 115 and save text identifying such words as being spoken during the associated frame. For example, voice tagging may identify the spoken word “Go!” as being associated with the start of action (e.g., the start of a race) that will be recorded in upcoming video frames. As another example, voice tagging may identify the spoken word “Wow!” as identifying an interesting event that is being recorded in the video frame or frames. Any number of words may be tagged in voice tagging track 240. In some embodiments, voice tagging may transcribe all spoken words into text and the text may be saved in voice tagging track 240.

In some embodiments, voice tagging track 240 may also identify background sounds such as for example, clapping, the start of music, the end of music, a dog barking, the sound of an engine, etc. Any type of sound may be identified as a background sound. In some embodiments, voice tagging may also include information specifying the direction of a voice or a background sound. For example, if the camera has multiple microphones it may triangulate the direction from which the sound is coming from and specify the direction in the voice tagging track.

In some embodiments, a separate background noise track may be used that captures and records various background tags.

Motion tagging track 245 may include data indicating various motion-related data such as, for example, acceleration data, velocity data, speed data, zooming out data, zooming in data, etc. Some motion data may be derived, for example, from data sampled from the motion sensor 135 or the GPS sensor 130 and/or from data in the motion track 220 and/or the geolocation track 225. Certain accelerations or changes in acceleration that occur in a video frame or a series of video frames (e.g., changes in motion data above a specified threshold) may result in the video frame, a plurality of video frames or a certain time being tagged to indicate the occurrence of certain events of the camera such as, for example, rotations, drops, stops, starts, beginning action, bumps, jerks, etc. Motion tagging may occur in real time or during post processing.

People tagging track 250 may include data that indicates the names of people within a video frame as well as rectangle information that represents the approximate location of the person (or person's face) within the video frame. People tagging track 250 may include a plurality of sub-tracks. Each sub-track, for example, may include the name of an individual as a data element and the rectangle information for the individual. In some embodiments, the name of the individual may be placed in one out of a plurality of video frames to conserve data.

The rectangle information, for example, may be represented by four comma-delimited decimal values, such as “0.25, 0.25, 0.25, 0.25.” The first two values may specify the top-left coordinate; the final two specify the height and width of the rectangle. The dimensions of the image for the purposes of defining people rectangles are normalized to 1, which means that in the “0.25, 0.25, 0.25, 0.25” example, the rectangle starts ¼ of the distance from the top and ¼ of the distance from the left of the image. Both the height and width of the rectangle are ¼ of the size of their respective image dimensions.

People tagging can occur in real time as the video is being recorded or during post processing. People tagging may also occur in conjunction with a social network application that identifies people in images and uses such information to tag people in the video frames and adding people's names and rectangle information to people tagging track 250. Any tagging algorithm or routine may be used for people tagging.

Data that includes motion tagging, people tagging, and/or voice tagging may be considered processed metadata. Other tagging or data may also be processed metadata. Processed metadata may be created from inputs, for example, from sensors, video and/or audio.

In some embodiments, discrete tracks (e.g., the motion track 220, the geolocation track 225, the other sensor track 230, the open track 235, the voice tagging track 240, the motion tagging track 245, and/or the people tagging track) may span more than video frame. For example, a single GPS data entry may be made in geolocation track 225 that spans five video frames in order to lower the amount of data in data structure 200. The number of video frames spanned by data in a discrete track may vary based on a standard or be set for each video segment and indicated in metadata within, for example, a header.

Various other tracks may be used and/or reserved within data structure 200. For example, an additional discrete or continuous track may include data specifying user information, hardware data, lighting data, time information, temperature data, barometric pressure, compass data, clock, timing, time stamp, etc.

In some embodiments, an additional track may include a video frame quality track. For example, a video frame quality track may indicate the quality of a video frame or a group of video frames based on, for example, whether the video frame is over-exposed, under-exposed, in-focus, out of focus, red eye issues, etc. as well as, for example, the type of objects in the video frame such as faces, landscapes, cars, indoors, out of doors, etc.

Although not illustrated, audio tracks 210, 211, 212 and 213 may also be discrete tracks based on the timing of each video frame. For example, audio data may also be encapsulated on a frame by frame basis.

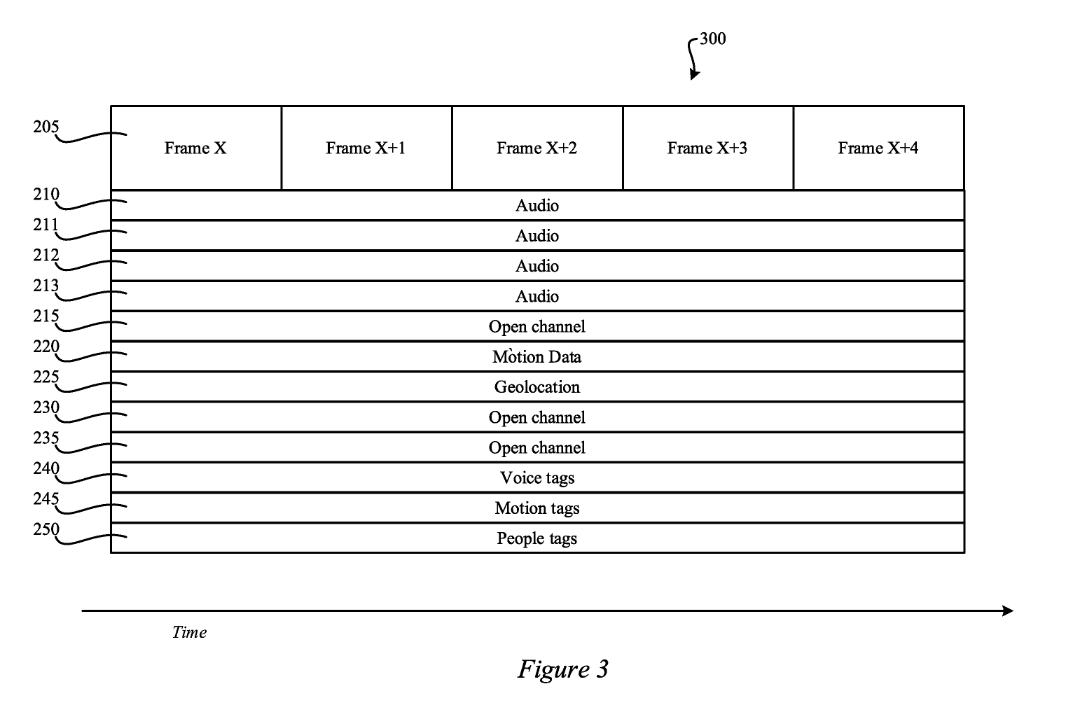

FIG. 3 illustrates data structure 300, which is somewhat similar to data structure 200, except that all data tracks are continuous tracks according to some embodiments described herein. The data structure 300 shows how various components are contained or wrapped within data structure 300. The data structure 300 includes the same tracks. Each track may include data that is time stamped based on the time the data was sampled or the time the data was saved as metadata. Each track may have different or the same sampling rates. For example, motion data may be saved in the motion track 220 at one sampling rate, while geolocation data may be saved in the geolocation track 225 at a different sampling rate. The various sampling rates may depend on the type of data being sampled, or set based on a selected rate.

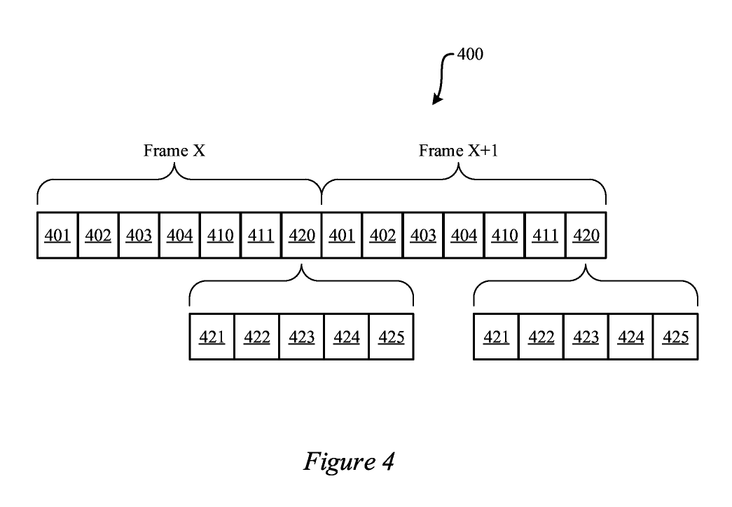

FIG. 4 shows another example of a packetized video data structure 400 that includes metadata according to some embodiments described herein. Data structure 400 shows how various components are contained or wrapped within data structure 400. Data structure 400 shows how video, audio and metadata tracks may be contained within a data structure. Data structure 400, for example, may be an extension and/or include portions of various types of compression formats such as, for example, MPEG-4 part 14 and/or Quicktime formats. Data structure 400 may also be compatible with various other MPEG-4 types and/or other formats.

Data structure 400 includes four video tracks 401, 402, 403 and 404, and two audio tracks 410 and 411. Data structure 400 also include metadata track 420, which may include any type of metadata. Metadata track 420 may be flexible in order to hold different types or amounts of metadata within the metadata track. As illustrated, metadata track 420 may include, for example, a geolocation sub-track 421, a motion sub-track 422, a voice tag sub-track 423, a motion tag sub-track 423, and/or a people tag sub-track 424. Various other sub-tracks may be included.

Metadata track 420 may include a header that specifies the types of sub-tracks contained with the metadata track 420 and/or the amount of data contained with the metadata track 420. Alternatively and/or additionally, the header may be found at the beginning of the data structure or as part of the first metadata track.

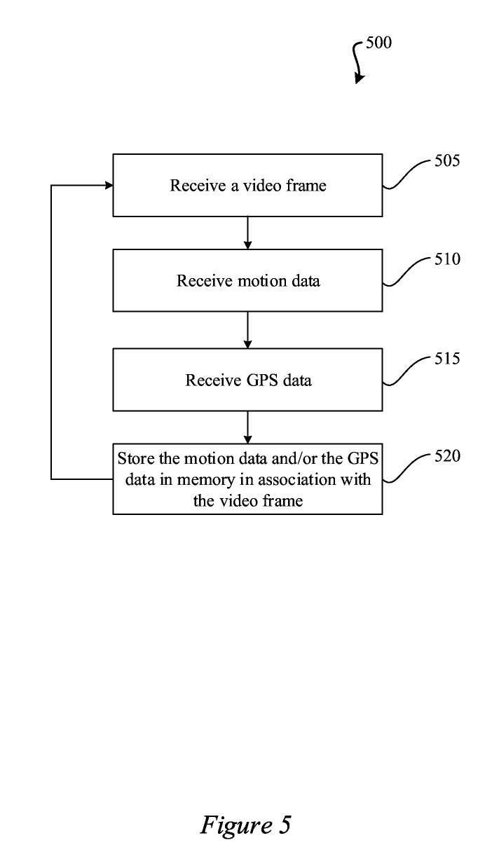

FIG. 5 illustrates an example flowchart of a process 500 for associating motion and/or geolocation data with video frames according to some embodiments described herein. Process 500 starts at block 505 where video data is received from the video camera 110. At block 510 motion data may be sampled from the motion sensor 135 and/or at block 515 geolocation data may be sampled from the GPS sensor 130. Blocks 510 and 515 may occur in any order. Moreover, either of blocks 510 and 515 may be skipped or may not occur in process 500. Furthermore, either of blocks 510 and/or 515 may occur asynchronously relative to block 505. The motion data and/or the geolocation data may be sampled at the same time as the video frame is sampled (received) from the video camera.

At block 520 the motion data and/or the GPS data may be stored into the memory 125 in association with the video frame. For example, the motion data and/or the GPS data and the video frame may be time stamped with the same time stamp. As another example, the motion data and/or the geolocation data may be saved in the data structure 200 at the same time as the video frame is saved in memory. As another example, the motion data and/or the geolocation data may be saved into the memory 125 separately from the video frame. At some later point in time the motion data and/or the geolocation data may be combined with the video frame (and/or other data) into data structure 200.

Process 500 may then return to block 505 where another video frame is received. Process 500 may continue to receive video frames, GPS data, and/or motion data until a stop signal or command to stop recording video is received. For example, in video formats where video data is recorded at 50 frames per second, process 500 may repeat 30 times per second.

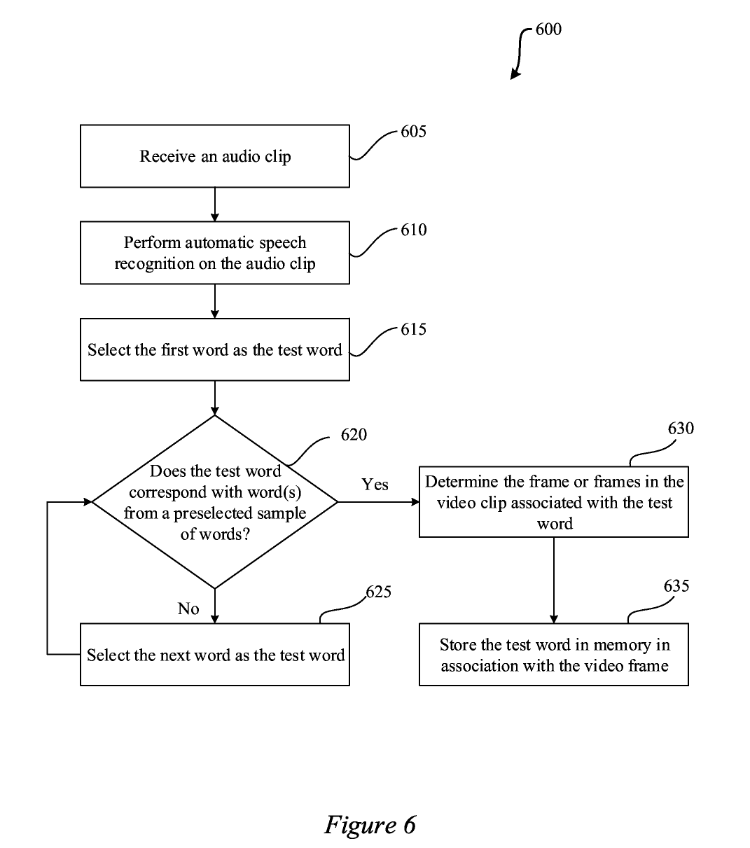

FIG. 6 illustrates an example flowchart of a process 600 for voice tagging video frames according to some embodiments described herein. Process 600 begins at block 605 where an audio clip from the audio track (e.g., one or more of audio tracks 210, 211, 212, or 213) of a video clip or an audio clip associated with the video clip is received. The audio clip may be received from the memory 125.

At block 610 speech recognition may be performed on the audio clip and text of words spoken in the audio clip may be returned. Any type of speech recognition algorithm may be used such as, for example, hidden Markov models speech recognition, dynamic time warping speech recognition, neural network speech recognition, etc. In some embodiments, speech recognition may be performed by an algorithm at a remote server.

At block 615, the first word may be selected as the test word. The term “word” may include one or more words or a phrase. At block 620 it can be determined whether the test word corresponds or is the same as with word(s) from a preselected sample of words. The preselected sample of words may be a dynamic sample that is user or situation specific and/or may be saved in the memory 125. The preselected sample of words may include, for example, words or phrases that may be used when recording a video clip to indicate some type of action such as, for example, “start,” “go,” “stop,” “the end,” “wow,” “mark, set, go,” “ready, set, go,” etc. The preselected sample of words may include, for example, words or phrases associated with the name of individuals recorded in the video clip, the name of the location where the video clip was recorded, a description of the action in the video clip, etc.

If the test word does not correspond with word(s) from a preselected sample of words then process 600 moves to block 625 and the next word or words is selected as the test word and process 600 returns back to block 620.

If the test word does correspond with word(s) from a preselected sample of words then process 600 moves to block 630. At block 630 the video frame or frames in the video clip associated with the test word can be identified and, at block 635, the test word can be stored in association with these video frames and/or saved with the same time stamp as one or both video frames. For example, if the duration of the test word or phrase is spoken over 20 video frames of the video clip, then the test word is stored in data structure 200 within the voice tagging track 240 associated with the 20 video frames.

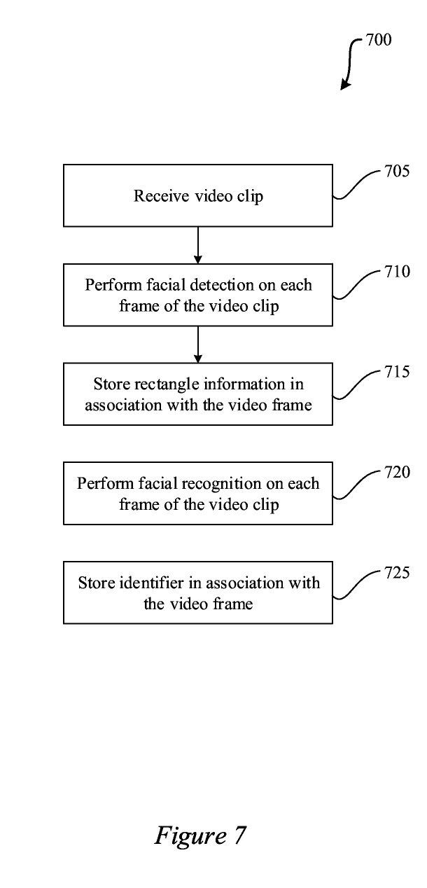

FIG. 7 illustrates an example flowchart of a process 700 for people tagging video frames according to some embodiments described herein. Process 700 begins at block 705 where a video clip is received, for example, from the memory 125. At block 710 facial detection may be performed on each video frame of the video clip and rectangle information for each face within the video clip may be returned. The rectangle information may determine the location of each face and a rectangle that roughly corresponds to the dimension of the face within the video clip. Any type of facial detection algorithm may be used. At block 715 the rectangular information may be saved in the memory 125 in association with each video frame and/or time stamped with the same time stamp as each corresponding video frame. For example, the rectangular information may be saved in people tagging track 250.

At block 720 facial recognition may be performed on each face identified in block 710 of each video frame. Any type of facial recognition algorithm may be used. Facial recognition may return the name or some other identifier of each face detected in block 710. Facial recognition may, for example, use social networking sites (e.g., Facebook) to determine the identity of each face. As another example, user input may be used to identify a face. As yet another example, the identification of a face within a previous face may also be used to identify an individual in a later frame. Regardless of the technique used, at block 725 the identifier may be stored in the memory 125 in association with the video frame and/or time stamped with the same time stamp as the video frame. For example, the identifier (or name of the person) may be saved in people tagging track 250.

In some embodiments, blocks 710 and 720 may be performed by a single facial determination-recognition algorithm and the rectangular data and the face identifier may be saved in a single step.

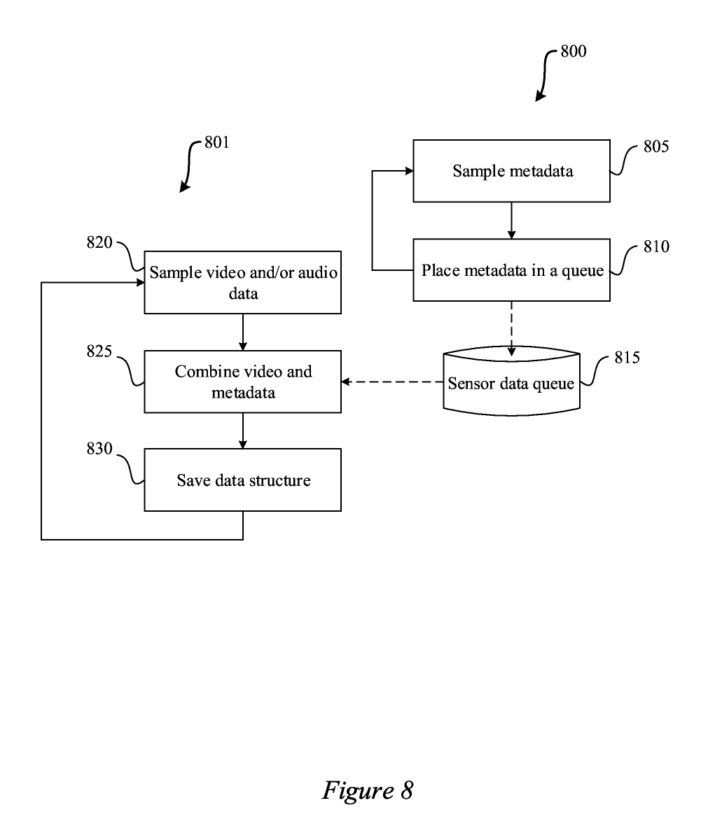

FIG. 8 is an example flowchart of a process 800 and process 801 for sampling and combining video and metadata according to some embodiments described herein. Process 800 starts at block 805. At block 805 metadata is sampled. Metadata may include any type of data such as, for example, data sampled from a motion sensor, a GPS sensor, a telemetry sensor, an accelerometer, a gyroscope, a magnetometer, etc. Metadata may also include data representing various video or audio tags such as people tags, audio tags, motion tags, etc. Metadata may also include any type of data described herein.

At block 810, the metadata may be stored in a queue 815. The queue 815 may include or be part of memory 125. The queue 815 may be a FIFO or LIFO queue. The metadata may be sampled with a set sample rate that may or may not be the same as the number of frames of video data being recorded per second. The metadata may also be time stamped. Process 800 may then return to block 805.

Process 801 starts at block 820. At block 820 video and/or audio is sampled from, for example, camera 110 and/or microphone 115. The video data may be sampled as a video frame. This video and/or audio data may be sampled synchronously or asynchronously from the sampling of the metadata in blocks 805 and/or 810. At block 825 the video data may be combined with metadata in the queue 815. If metadata is in the queue 815, then that metadata is saved with the video frame as a part of a data structure (e.g., data structure 200 or 300) at block 830. If no metadata is in the queue 815, then nothing is saved with the video at block 830. Process 801 may then return to block 820.

In some embodiments, the queue 815 may only save the most recent metadata. In such embodiments, the queue may be a single data storage location. When metadata is pulled from the queue 815 at block 825, the metadata may be deleted form the queue 815. In this way, metadata may be combined with the video and/or audio data only when such metadata is available in queue 815.

The computational system 900 (or processing unit) illustrated in FIG. 9 can be used to perform any of the embodiments of the invention. For example, the computational system 900 can be used alone or in conjunction with other components to execute all or parts of the processes 500, 600, 700 and/or 800. As another example, the computational system 900 can be used to perform any calculation, solve any equation, perform any identification, and/or make any determination described here. The computational system 900 includes hardware elements that can be electrically coupled via a bus 905 (or may otherwise be in communication, as appropriate). The hardware elements can include one or more processors 910, including, without limitation, one or more general purpose processors and/or one or more special purpose processors (such as digital signal processing chips, graphics acceleration chips, and/or the like); one or more input devices 915, which can include, without limitation, a mouse, a keyboard, and/or the like; and one or more output devices 920, which can include, without limitation, a display device, a printer, and/or the like.

The computational system 900 may further include (and/or be in communication with) one or more storage devices 925, which can include, without limitation, local and/or network-accessible storage and/or can include, without limitation, a disk drive, a drive array, an optical storage device, a solid-state storage device, such as random access memory (“RAM”) and/or read-only memory (“ROM”), which can be programmable, flash-updateable, and/or the like. The computational system 900 might also include a communications subsystem 930, which can include, without limitation, a modem, a network card (wireless or wired), an infrared communication device, a wireless communication device, and/or chipset (such as a Bluetooth device, an 902.6 device, a Wi-Fi device, a WiMAX device, cellular communication facilities, etc.), and/or the like. The communications subsystem 930 may permit data to be exchanged with a network (such as the network described below, to name one example) and/or any other devices described herein. In many embodiments, the computational system 900 will further include a working memory 935, which can include a RAM or ROM device, as described above. Memory 125 shown in FIG. 1 may include all or portions of working memory 935 and/or storage device(s) 925.

The computational system 900 also can include software elements, shown as being currently located within the working memory 935, including an operating system 940 and/or other code, such as one or more application programs 945, which may include computer programs of the invention and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 925 described above.

In some cases, the storage medium might be incorporated within the computational system 900 or in communication with the computational system 900. In other embodiments, the storage medium might be separate from the computational system 900 (e.g., a removable medium, such as a compact disk, etc.), and/or provided in an installation package, such that the storage medium can be used to program a general purpose computer with the instructions/code stored thereon. These instructions might take the form of executable code, which is executable by the computational system 900 and/or might take the form of source and/or installable code, which, upon compilation and/or installation on the computational system 900 (e.g., using any of a variety of generally available compilers, installation programs, compression/decompression utilities, etc.), then takes the form of executable code.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing art to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical, electronic, or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art.

That which is claimed:

1. A camera comprising:
an image sensor;
a motion sensor;
a memory; and
a processing unit electrically coupled with the image sensor, the microphone, the motion sensor, and the memory, wherein the processing unit is configured to:
receive a plurality of video frames from the image sensor, wherein the plurality of video frames comprise a video clip;
receive motion data from the motion sensor; and
store the motion data in association with the video clip.

2. The camera according to claim 1, wherein the motion data is stored in association with each of the plurality of video frames.

3. The camera according to claim 1, wherein:
the motion data comprises first motion data and a second motion data;
the plurality of video frames comprise a first video frame and a second video frame;
the first motion data is stored in association with the first video frame; and
the second motion data is stored in association with the second video frame.

4. The camera according to claim 3, wherein the first motion data and the first video frame are time stamped with a first time stamp, and the second motion data and the second video frame are time stamped with a second time stamp.

5. The camera according to claim 1, wherein the motion sensor comprises a sensor consisting of one or more of an accelerometer, a gyroscope, and a magnetometer.

6. The camera according to claim 1, wherein the processing unit is further configured to:
determine processed metadata from the motion data; and
store the processed metadata in association with the video clip.

7. The camera according to claim 1, wherein the processing unit is further configured to:
determine processed metadata from the plurality of video frames; and
store the processed metadata in association with the video clip.

8. The camera according to claim 1, wherein the motion data is received asynchronously relative to the video frames.

9. A method for collecting video data, the method comprising:
receiving a plurality of video frames from an image sensor, wherein the plurality of video frames comprise a video clip;
receiving motion data from a motion sensor; and
storing the motion data as metadata with the video clip.

10. The method according to claim 9, wherein the motion sensor comprises one or more motion sensors selected from the group consisting of a GPS sensor, a telemetry sensor, an accelerometer, a gyroscope, and a magnetometer.

11. The method according to claim 9, wherein the motion tag is stored in association with each of the plurality of video frames.

12. The method according to claim 9, further comprising:
determining processed metadata from the motion data; and
storing the processed metadata in association with the video clip.

13. The method according to claim 9, further comprising:
determining processed metadata from the video frames; and
storing the processed metadata in association with the video clip.

14. The method according to claim 13, wherein the processed metadata comprises metadata selected from the list consisting of voice tagging data, people tagging, rectangle information that represents the approximate location of a person's face.

15. The method according to claim 9, wherein the motion data comprises one or more data selected from the list consisting of acceleration data, angular rotation data, direction data, and a rotation matrix.

16. The method according to claim 9, further comprising:
receiving GPS data from a GPS sensor; and
storing the GPS data as metadata with the video clip.

17. The method according to claim 16, wherein the GPS data comprises one or more data selected from the list consisting of a latitude, a longitude, an altitude, a time of the fix with the satellites, a number representing the number of satellites used to determine GPS data, a bearing, and a speed.

18. A method for collecting video data, the method comprising:
receiving a video data from an image sensor;
receiving motion data from a motion sensor;
determining processed metadata from either of both the video data and the motion data; and
storing the motion data and the processed metadata in conjunction with the video data.

19. The method according to claim 18, wherein the motion data is received asynchronously relative to the video data.

20. The method according to claim 18, wherein the motion sensor comprises one or more motion sensors selected from the group consisting of a GPS sensor, a telemetry sensor, an accelerometer, a gyroscope, and a magnetometer.

21. The method according to claim 18, wherein the processed metadata comprises metadata selected from the list consisting of voice tagging data, people tagging, rectangle information that represents the approximate location of a person's face
